(19) United States
(12) Patent Application Publication
(10) Pub. No.: US 2024/0403583 A1
(43) Pub. Date: Dec. 5, 2024

(54) OPTICAL FLOW ESTIMATION METHOD FOR 1D/2D DECODING IMPROVEMENTS

(71) Applicant: Zebra Technologies Corporation, Lincolnshire, IL (US)

(72) Inventors: Raveen T. Thrimawithana, Pannipitiya (LK); Anotoly Kotlarsky, Churchville, PA (US)

(21) Appl. No.: 18/696,446

(22) PCT Filed: Sep. 15, 2022
(86) PCT No.: PCT/US2022/043628

§ 371 Date: Mar. 28, 2024

Related U.S. Application Data
(60) Provisional application No. 63/250,325, filed on Sep. 30, 2021.

(51) Int. Cl. G06K 7/10; G06K 7/14; G06T 7/246

(52) U.S. Cl. CPC G06K 7/10722; G06K 7/1413; G06T 7/248; G06T 2207/30204

(57) ABSTRACT

Methods and apparatuses for optical flow estimation for 1D/2D decoding improvements are disclosed herein. An example method includes receiving, from the optical imaging assembly, a series of images including at least a first image and a second image captured over the FOV; decoding a barcode in the first image; identifying a first position of a key-point within the first image; identifying a second position of the key-point within the second image; calculating an optical flow for the barcode based on at least the first position and the second position; and tracking the barcode based on the optical flow.

### CROSS-REFERENCE TO RELATED APPLICATIONS

This application is a national stage filing of PCT application PCT/US2022/43628, filed Sep. 15, 2022, which claims priority to U.S. Provisional Patent Application No. 63/250,325, filed Sep. 30, 2021, the entire contents of which is incorporated herein by reference.

### BACKGROUND

A barcode reader may not always identify items correctly. For example, an item may be passed across a barcode reader, but the item barcode may not be read. Further, a barcode reader may mistake multiple substantially similar or identical barcodes as being identical or may mistake a single item barcode as being multiple when held in place. Accordingly, there is a need for systems to increase item identification accuracy.

### SUMMARY

In an embodiment, the present invention is a method for object tracking using an imaging system including an optical assembly having a field of view (FOV). The method includes receiving, from the optical imaging assembly, a series of images including at least a first image and a second image captured over the FOV; decoding a barcode in the first image; identifying a first position of a key-point within the first image, wherein the key-point is based on the barcode; identifying a second position of the key-point within the second image; calculating an optical flow for the barcode based on at least the first position and the second position; and tracking the barcode based on the optical flow.

In a variation of this embodiment, the first position is defined by a first x coordinate and a first y coordinate within the first image; the second position is defined by a second x coordinate and a second y coordinate within the second image; and calculating the optical flow includes: calculating a first distance between the first x coordinate and the second x coordinate; calculating a second distance between the first y coordinate and the second y coordinate; determining a direction of movement based on the first distance and the second distance; and determining a movement vector for the optical flow based at least on the first distance, the second distance, and the direction of movement.

In another variation of this embodiment, the tracking includes predicting, using at least the optical flow and the key-point, a location of the barcode in an additional image of the series of images, wherein the additional image is taken after the first image.

In yet another variation of this embodiment, the method further includes: decoding the barcode in the additional image; determining an additional position of the decoded barcode; comparing the predicted location of the barcode and the additional position of the decoded barcode in the additional image; determining that the additional position of the barcode and the predicted location of the barcode overlap; and updating the optical flow using the additional position.

In still yet another variation of this embodiment, the method further includes: decoding the barcode in the additional image; determining an additional position of the decoded barcode; comparing the predicted location of the barcode and the additional position of the decoded barcode in the additional image; determining that the additional position of the barcode and the predicted location of the barcode overlap; and updating the optical flow using the additional position.

In another variation of this embodiment, the key-point is a first key-point, the barcode is a first barcode, the optical flow is a first optical flow, and further comprising: determining that a second barcode is present in a third image of the series of images; decoding a second barcode; identifying a first position of a second key-point within the image; identifying a second position of the second key-point within a fourth image; calculating a second optical flow for the second barcode based on at least the first position of the second key-point and the second position of the second key-point; and tracking the second barcode based on the optical flow.

In yet another variation of this embodiment, tracking the second barcode and tracking the first barcode are performed simultaneously.

In still yet another variation of this embodiment, the method further includes decoding a portion of an additional image of the series of images, wherein the additional image is taken after the first image and wherein the portion does not include the predicted location

In another variation of this embodiment, the calculating and the tracking are performed in real time.

In yet another variation of this embodiment, identifying the first position of the key-point includes: generating a signature for the key-point, the signature including information on gradients surrounding the key-point.

In still yet another variation of this embodiment, identifying the second position of the key-point includes: determining that a key-point in the second image has a signature that matches the signature for the key-point.

In another embodiment, the present invention is a method for object tracking using an imaging system including an optical assembly having a field of view (FOV). The method includes receiving, from the optical imaging assembly, a series of images including at least a first image and a second image captured over the FOV; decoding a barcode in the first image; identifying a position of a key-point within the first image; receiving optical flow data for the key-point; and tracking the barcode based on the optical flow data.

In a variation of this embodiment, the tracking includes predicting, using at least the optical flow data and the key-point, a location of the barcode in an additional image of the series of images, wherein the additional image is taken after the first image.

In another variation of this embodiment, the method further includes decoding the barcode in the additional image; determining an additional position of the decoded barcode; comparing the predicted location of the barcode and the additional position of the decoded barcode in the additional image; determining that the additional position of the barcode and the predicted location of the barcode overlap; and updating the optical flow data using the additional position.

In yet another variation of this embodiment, decoding a barcode in the additional image; determining an additional position of the decoded barcode; comparing the predicted location of the barcode and the additional position of the decoded barcode in the additional image; determining that the additional position of the barcode and the predicted location of the decoded barcode do not overlap; and in response to determining that the additional position of the barcode and the predicted location of the decoded barcode do not overlap, determining that the decoded barcode is different from the first barcode.

In still yet another variation of this embodiment, the position of the key-point is a first position of a first key-point, the barcode is a first barcode, the optical flow information is first optical flow data, and the method further comprises determining that a second barcode is present in a third image of the series of images; decoding a second barcode; identifying a second position of a second key-point within the image; receiving second optical flow data for the second key-point; and tracking the second barcode based on the second optical flow data.

In another variation of this embodiment, tracking the second barcode and tracking the first barcode are performed simultaneously.

In yet another variation of this embodiment, the method further includes decoding a portion of an additional image of the series of images, wherein the additional image is taken after the first image and wherein the portion does not include the predicted location.

In still yet another variation of this embodiment, the receiving and the tracking are performed in real time.

In another variation of this embodiment, identifying the position of the key-point includes: generating a signature for the key-point, the signature including information on gradients surrounding the key-point.

In another embodiment, the present invention is a method for object tracking using an imaging system including an optical assembly having a field of view (FOV). The method includes receiving, from the optical imaging assembly, a series of images including at least a first image and a second image captured over the FOV; identifying a first region of interest (ROI) within the first image and a second ROI within the second image, wherein the first ROI and the second ROI are based on an object common to the first image and the second image; determining a first position of the first ROI within the first image and a second position of the second ROI within the second image; identifying an optical flow for the object based on at least the first position and the second position, wherein the optical flow is representative of a change in position between the first position and the second position; and tracking the object based on the optical flow.

In a variation of this embodiment, identifying the optical flow further includes calculating a distance between the first position and the second position; determining a direction of movement for the object based on the first position and the second position; and determining a movement vector for the object based on the distance and the direction of movement.

In another variation of this embodiment, determining the first position of the first ROI includes determining a first position of at least some of a plurality of pixels within the first ROI within the first image; determining the second position of the second ROI includes determining a second position of at least some of the plurality of pixels within the second ROI within the second image; and determining the distance between the first position and the second position includes determining a distance between (i) the first position of the some of the plurality of pixels and (ii) the second position of the some of the plurality of pixels.

In yet another variation of this embodiment, the method further includes determining that the movement vector is below a pre-determined threshold for a predetermined period of time; and indicating that the object has been scanned previously.

In still yet another variation of this embodiment, the method further includes calculating, using a predictive algorithm, a third position of a third ROI based on the first position and the second position; and updating the optical flow based on the third position.

In another variation of this embodiment, tracking the object includes receiving, from the optical imaging assembly, a third image of the series of images captured over the FOV; calculating an estimated optical flow based at least on the second position and the optical flow; cropping a predicted ROI of the third image based on the estimated optical flow; determining that the predicted ROI contains the object; and updating the optical flow with the estimated optical flow.

In yet another variation of this embodiment, tracking the object includes determining that a distance between the first position and the second position is greater than a predetermined lower threshold and less than a predetermined upper threshold, and identifying the optical flow is in response to determining that the distance is greater than the predetermined lower threshold and less than the predetermined upper threshold.

In still yet another variation of this embodiment, the series of images is a first series of images and the object is a first object. The method further includes receiving, from the optical imaging assembly, a second series of images including at least a third image and a fourth image captured over the FOV; identifying a third ROI within the third image and a fourth ROI within the fourth image, based on a second object common to the third image and the fourth image; determining a third position of the third ROI within the third image and a fourth position of the fourth ROI within the fourth image; updating the optical flow based on the third position of the third ROI and the fourth position of the fourth ROI; and cropping the fourth ROI in response to determining that the first object is outside the FOV.

In another variation of this embodiment, identifying the third ROI includes determining that the third ROI is substantially similar to the first ROI; calculating a distance between the third ROI and the first ROI in the FOV; determining that the distance between the third ROI and the first ROI exceeds a pre-determined threshold; and determining that the third ROI is distinct from the first ROI based on the determination that the distance between the third ROI and the first ROI exceeds the pre-determined threshold.

In yet another variation of this embodiment, the method further includes directing an illumination source based on the tracking of the object.

In still another embodiment, the present invention is an imaging system for object tracking, comprising an optical imaging assembly having a field of view (FOV) and configured to capture a series of images including at least a first image and a second image over the FOV, and a controller. The controller is configured to receive, from the optical imaging assembly, the series of images including at least the first image and the second image captured over the FOV; identify a first region of interest (ROI) within the first image and a second ROI within the second image, wherein the first ROI and the second ROI are based on an object common to the first image and the second image; determine a first position of the first ROI within the first image and a second position of the second ROI within the second image; identify an optical flow for the object based on at least the first position and the second position, wherein the optical flow is representative of a change in position between the first position and the second position; and track the object based on the optical flow.

In variations of this embodiment, the system implements each of the methods as described above.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1A illustrates a perspective view of an example checkout workstation in accordance with the teachings of this disclosure.

FIG. 1B illustrates a perspective view of an example handheld barcode scanner in accordance with the teachings of this disclosure.

FIG. 2 illustrates a block schematic diagram of some of the components of a barcode reader of FIGS. 1A-1B according to an embodiment of the present invention.

FIG. 3A illustrates an image captured over the field of view (FOV) of the optical imaging assemblies of FIGS. 1A-1B.

FIG. 3B illustrates an image captured over the field of view (FOV) of the optical imaging assemblies of FIGS. 1A-1B.

FIG. 4 is a flowchart of a method for accurate object tracking according to an embodiment of the present invention.

FIG. 5 is a flowchart of a method for accurate object tracking according to another embodiment of the present invention.

FIG. 6 is a flowchart of a method for accurate object tracking according to yet another embodiment of the present invention.

FIG. 7 is a flowchart of a method for accurate object tracking according to still another embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

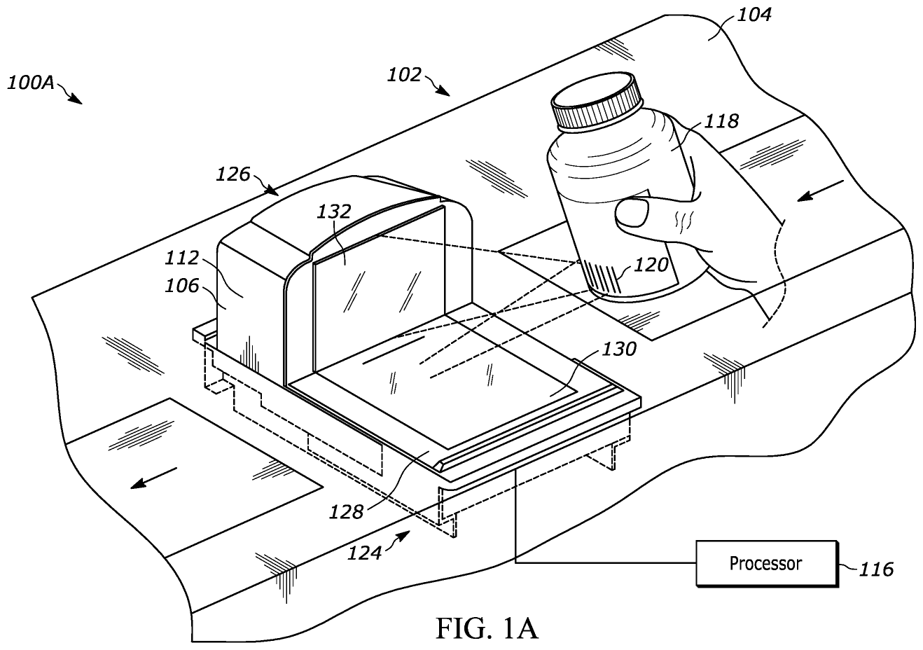

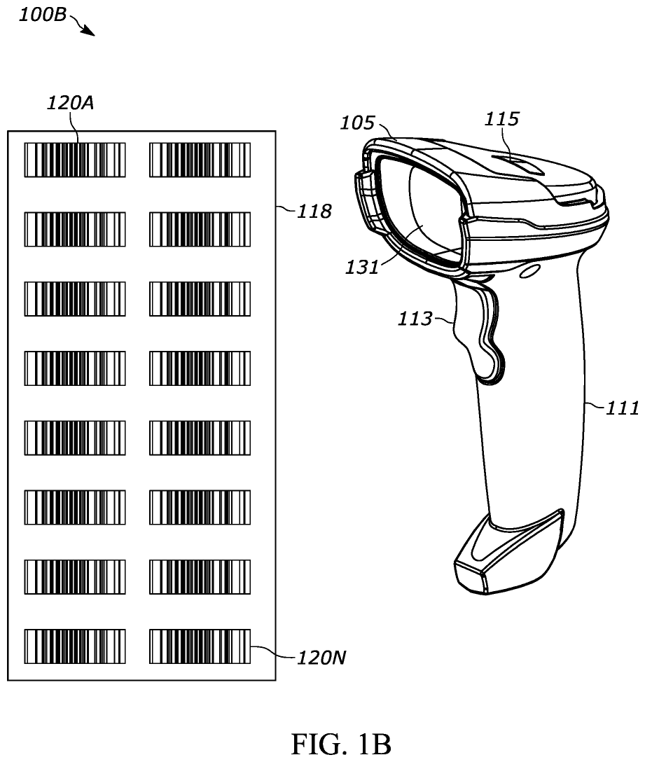

FIG. 1A illustrates a perspective view of an example scanning system 100A in accordance with the teachings of this disclosure. In the exemplary embodiment, the system 100A includes a workstation 102 with a counter 104 and a bi-optical (also referred to as “bi-optic”) barcode reader 106. The barcode reader 106 may also be referred to as a bi-optic scanner or an indicia reader. The scanning system 100A may be managed by a store employee such as a clerk. In other cases, the scanning system 100A may be part of a self-checkout lane wherein customers are responsible for checking out their own products.

The barcode reader 106 includes a housing 112 comprised of a lower housing 124 and a raised housing 126. The lower housing 124 may be referred to as a first housing portion and the raised housing 126 may be referred to as a tower or a second housing portion. The lower housing 124 includes a top portion 128 and houses an optical imaging assembly 130. In some embodiments, the top portion 128 may include a removable or a non-removable platter (e.g., a weighing platter). The top portion 128 can be viewed as being positioned substantially parallel with the counter 104 surface. In some implementations, the phrase “substantially parallel” within 10° of parallel. In further implementations, the phrase “substantially parallel” means the top portion 128 accounts for manufacturing tolerances. While the counter 104 and the top portion 128 are illustrated as being approximately co-planar in FIG. 1A, in other embodiments, the counter 104 may be raised or lowered relative to the top surface of the top portion 128, where the top portion 128 is still viewed as being positioned substantially parallel with the counter 104 surface.

The raised housing 126 is configured to extend above the top portion 128 and includes an optical imaging assembly 132. The raised housing 126 is positioned in a generally upright plane relative to the top portion 128. Note that references to “upright” include, but are not limited to, vertical. Thus, in some implementations, something that is upright may deviate from a vertical axis/plane by as much as 45 degrees.

Optical imaging assemblies 130 and 132 include at least one image sensor and are communicatively coupled to a processor 116. The image sensors may include one or more color cameras, one or more monochrome imagers, and/or one or more optical character readers. The processor 116 may be disposed within the barcode reader 106 or may be in another location. The optical imaging assemblies 130 and 132 are operable to capture one or more images of targets (e.g., target 118) within their respective fields of view (FOV). In the exemplary embodiment of FIG. 1A, optical imaging assemblies 130 and 132 are included in the same barcode reader 106. In other embodiments, the optical imaging assemblies 130 and 132 are included in different barcode readers.

The target 118 may be swiped past the barcode reader 106. In doing so, a product code 120 associated with the target 118 is positioned within the FOV of the optical imaging assemblies 130 and 132. The product code 120 may be a bar code, a radio-frequency identification (RFID) tag, a quick response (QR) code, and/or any other product-identifying code.

FIG. 1B illustrates a perspective view of another example scanning system 100B in accordance with the teachings of this disclosure. In the exemplary embodiment, the system 100B includes a handheld barcode reader 105. In some implementations, the barcode reader may be bi-optic, as described above. The scanning system may be managed by a store employee such as a clerk, a customer, a warehouse employee, or any similar individual.

The barcode reader 105 includes a housing 111, which, in addition to the housing 111 shell, further includes at least a trigger 113 and a button 115. In some implementations, the housing 111 of the barcode reader is designed such that the barcode reader 105 can connect with a docking station (not shown). The housing 111 further includes an optical imaging assembly 131. The optical imaging assembly 131 includes at least one image sensor and is communicatively coupled to a processor 117. The image sensors may include one or more color cameras, one or more monochrome imagers, and/or one or more optical character readers. The processor 117 may be disposed within the barcode reader 105 or may be in another location. The optical imaging assembly 131 is operable to capture one or more images of targets (e.g., target 118) within the FOV.

When pressed and/or depressed, the trigger 113 may activate a decode processing function of the barcode reader 105. In some implementations, the decode processing function remains active so long as the trigger is pressed and/or depressed. In other implementations, the decode processing function remains active after the trigger is pressed and/or depressed for a set period of time. Depending on the implementation, the period of time may be modified via the button 115. This method of functionality is referred to herein as a handheld mode or handheld functionality. Alternatively, the barcode reader 105 may function in a presentation mode or presentation functionality, in which the barcode reader 105 activates decode processing when the barcode reader 105 detects a barcode. In some implementations, the button 115 may cause a transition between the handheld mode and the presentation mode. In further implementations, the barcode reader 105 may detect that the reader 105 has been placed in docking station (not shown) and automatically activate presentation mode.

The target 118 may be swiped past the barcode reader 105 operating in a presentation mode. In doing so, one or more product codes 120A-120N associated with the target 118 are positioned within the FOV of the optical imaging assembly 131. Alternatively, the barcode reader may be utilized in a handheld mode and swiped over the target 118 to similar effect. The product code may be a bar code, a radio-frequency identification (RFID) tag, a quick response (QR) code, and/or any other product-identifying code.

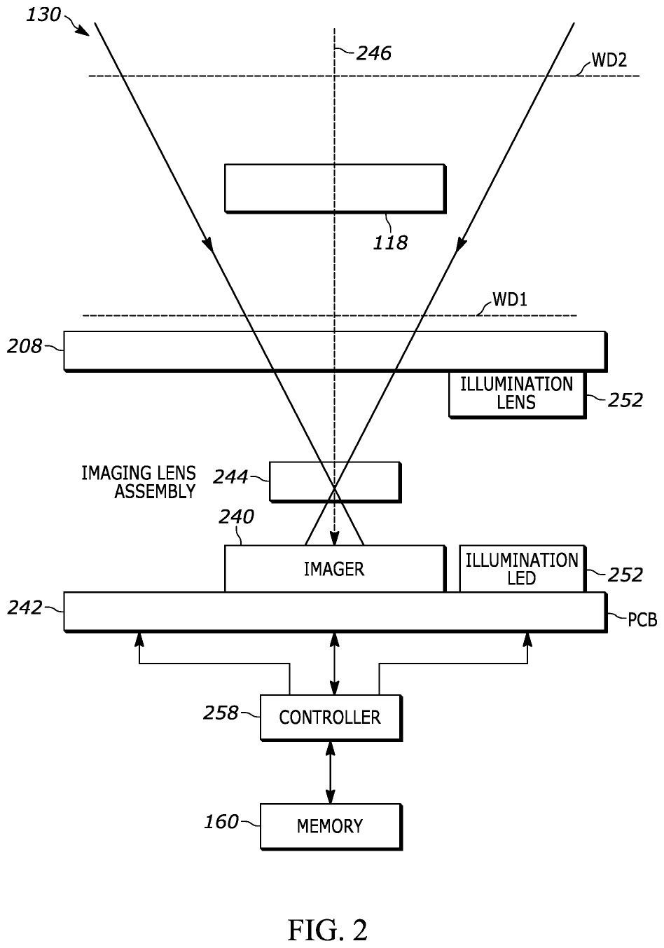

Referring to FIG. 2, the optical imaging assembly 130/131 includes a light-detecting sensor or imager 240 operatively coupled to, or mounted on, a printed circuit board (PCB) 242 in the lower portion 124 or the housing 111/112, depending on the implementation. Top portion 128 including optical imaging assembly 132 may have a substantially similar configuration. In an embodiment, the imager 240 is a solid state device, for example a CCD or a CMOS imager, having a one-dimensional array of addressable image sensors or pixels arranged in a single row, or a two-dimensional array of addressable image sensors or pixels arranged in mutually orthogonal rows and columns, and operative for detecting return light captured by an imaging lens assembly 244 over a FOV along an imaging axis 246 through the window 208. The return light is scattered and/or reflected from a target (e.g., target 118) over the FOV. The imaging lens assembly 244 is operative for focusing the return light onto the array of image sensors to enable the target 118, and more particularly product code 120 (or product codes 120A-N), to be read. The target 118 may be located anywhere in a working range of distances between a close-in working distance (WD1) and a far-out working distance (WD2). In an implementation, WD1 is about one-half inch from the window 208, and WD2 is about thirty inches from the window 208.

An illuminating light assembly is also mounted in the barcode reader 105/106 in connection with optical imaging assembly 130/131 and within lower portion 124 or the housing 111/112, depending on the implementation. The illuminating light assembly includes an illumination light source, such as at least one light emitting diode (LED) 250 and at least one illumination lens 252. In some implementations, the illuminating light assembly includes multiple LEDs 350 and illumination lenses 252. The illumination light source is configured to generate a substantially uniform distributed illumination pattern of illumination light on and along the target 118 to be read by image capture. At least part of the scattered and/or reflected return light is derived from the illumination pattern of light on and along the target 118.

As also shown in FIG. 2, the imager 240 and the illumination LED 250 are operatively connected to a controller or programmed microprocessor, for example controller 258, operative for controlling the operation of these components. A memory 160 is coupled and accessible to the controller 258. Controller 258 may additionally be configured to control optical imaging assembly 130/131/132 and associated illumination LED. In alternate implementations, optical imaging assembly 130 and optical imaging assembly 132 may be controlled by different controllers. The controller 258 may send information (i.e., one or more images and/or image data) to a processor (e.g., processors 116 or 117) for further processing. Alternatively, controller 258 may include processor 116 or 117. Further, while the optical imaging assemblies 130 and 132 are shown in FIG. 1A as perpendicular, the optical imaging assemblies may be coplanar or in any other arrangement with overlapping FOV.

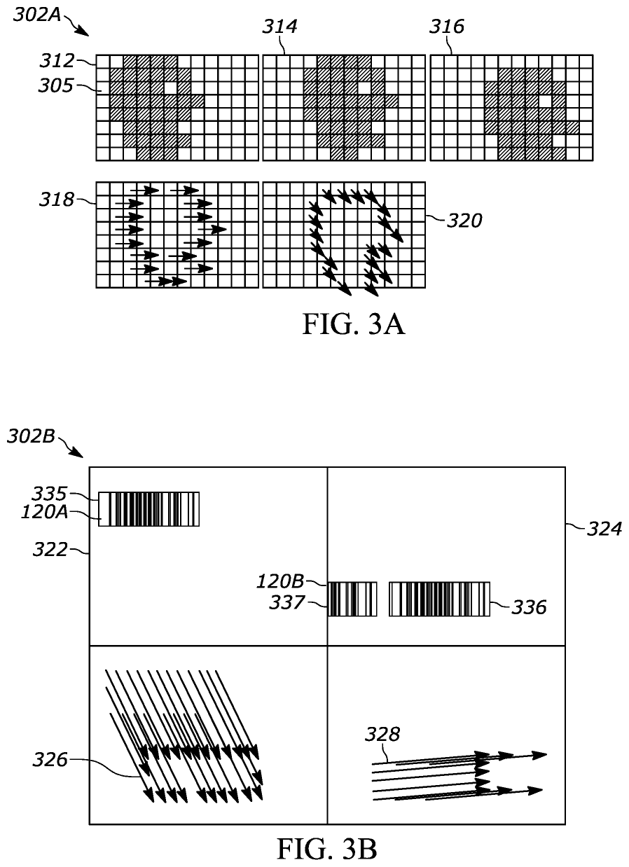

FIG. 3A illustrates a series of images 302A including first image 312, second image 314, and third image 316 captured by the optical imaging assembly 130/131 over a FOV, and optical flows 318 and 320 calculated between each set of images. The images include, for example, a face or other object of interest 305. In some implementations, the object of interest 305 is the target 118 described in FIGS. 1A-1B above. The controller (e.g., controller 258) may divide each image in the series 302A into a grid of pixels for analysis. The series of images 302 may depict the movement of the object of interest 305 across the FOV.

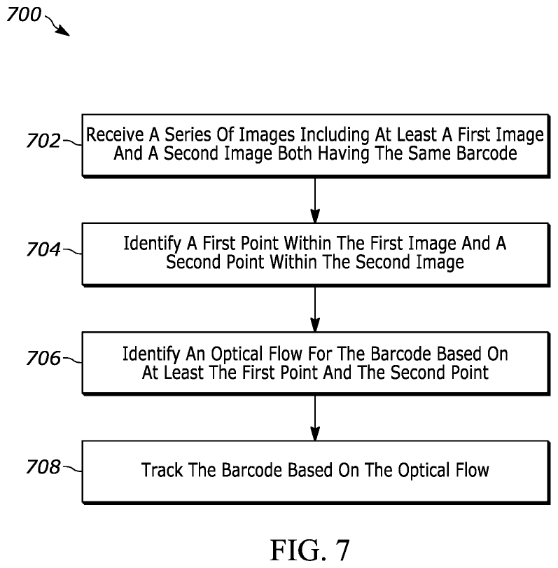

In an exemplary embodiment of FIG. 3A, optical flows 318 and 320 depict the movement of the object of interest between each of images 312/314 and 314/316, respectively. For clarity, the exemplary first image 312, second image 314, and optical flow 318 are discussed below. In some implementations, to determine the optical flow 318, the controller 258 first determines a first location for each pixel in the first image 312. The controller 258 then determines a second location for each pixel in the second image 314. To calculate the optical flow 318 between the first image 312 and the second image 314, the controller 258 calculates the distance between the first location and the second location of each pixel as well as determines the direction of movement. In some implementations, the controller 258 calculates the first location and the second location for every pixel of the object of interest. In other implementations, the controller 258 first creates an outline for the object of interest. The controller 258 may create such an outline by identifying each pixel on the edge of the object of interest. The controller 258 then calculates the first location and second location for every pixel that makes up the outline of the object of interest. In still other implementations, the controller 258 calculates a first location and a second location for a key-point on the object of interest. The key-point may be a corner, an edge, or a recognizable feature. Depending on the implementation, the controller 258 may define a key-point by the area surrounding it, as described in further detail with respect to FIG. 7 below.

In some implementations, the controller 258 logs and/or identifies a timestamp of the first image 312 and the second image 314. The timestamp may indicate a time and/or date of capture of the image or, alternatively, the timestamp may indicate a relative time of capture. The controller 258 may then use the timestamps to determine the optical flow 318 between the first image 312 and the second image 314.

FIG. 3B, similar to FIG. 3A, illustrates a series 302B of images 322 and 324 captured by the optical imaging assembly 130/131 over a FOV, and optical flow 326 between images 322 and 324. Unlike FIG. 3A, however, FIG. 3B further illustrates an estimated optical flow 328.

In an exemplary embodiment of FIG. 3B, the series of images 302B depicts an object of interest 305 with a product code 120 and the positioning of the object of interest 305 between different moments in time, as captured in images 322 and 324. The controller 258 may calculate the optical flow 326 as described in FIG. 3A above. In some implementations, the controller 258 may preemptively calculate an estimated optical flow 328 using a predictive algorithm, the first and second positions of the object of interest 305, and one or more already calculated optical flows 326. The predictive algorithm may, for example, be a Kalman filter algorithm. Depending on the implementation, the controller may utilize machine learning techniques to train the predictive algorithm to more accurately calculate the estimated optical flow 328.

In some implementations, the optical imaging assembly 130/131 captures the object of interest 305 as a whole, and the controller 258 tracks the entire object. In further implementations, the optical imaging assembly 130/131 may capture some or all of the object of interest 305, and the controller 258 may crop a region of interest (ROI) 335 of the object 305 that the controller 258 then tracks over the series of images 302B. The object 305 may include or consist of the product code 120. The object 305 may also include or consist of a product label, such as a label including a product name, company name, logo, and/or price. The controller 258 identifies the ROI 335 based on the object 305 present within each of the series of images 302B. In some implementations, the controller 258 identifies the ROI 335 based on an event associated with the ROI 335. For example, the controller 258 may decode a product code 120 on an object of interest 305 and, in response, determine that some or all of the object of interest 305 is an ROI 335. The controller 258 may then crop the ROI 335 of the object 305 and begin tracking the object 305 from the ROI 335 to a second ROI 336 and/or calculating an optical flow 326 for the object 305. In another implementation, the controller 258 detects motion within a pre-determined range from the optical imaging assembly 130/131 (e.g., such as between WD1 and WD2) and determines an ROI 335 for the moving object 305. In yet another implementation, a user manually denotes the ROI 335 using a physical trigger on a device, via a touch screen, or by selecting an input displayed to the user on a display screen. Other similar events that are known in the art may also serve as an event for identifying an ROI 335.

The object of interest 305 may be a target 118 with multiple product codes 120 as described in FIG. 1B. As such, the controller 258 may identify an ROI 337 for a second product code 120N. In some implementations, the first product code 120A and the second product code 120N may be substantially similar or identical. In such implementations, the controller 258 may use the optical flow 326 to distinguish between the first product code 120A and the second product code 120N. For example, the controller 258 may determine that an optical flow 326 or an estimated optical flow 328 of the first ROI 335 indicates that the first product code 120A is moving at a particular speed and in a particular direction that would make it unlikely to reach the position that the second product code 120N is at (i.e., ROI 337), and thus determine that the product code in a second ROI 336 and the product code in ROI 337 are different product codes. Alternatively, the controller 258 may determine that a product code present where the optical flow 326 indicates first product code 120A should be (i.e. ROI 336) is product code 120A. Further, in some implementations, the controller 258 determines whether a product code 120N is product code 120A based on the presence of one or more key-points for the product code 120A, as described with further detail in regard to FIG. 7 below. Similarly, the controller 258 may determine that only part of the first product code 120A should be visible in the FOV or only part of the second product code 120B is visible, and thus determines that the two ROIs 336 and 337 are different. In some implementations, the controller 258 may track and calculate optical flows 326 for each of the two product codes 120A and 120N simultaneously.

In further implementations, the controller 258 may determine whether a product code 120 is remaining relatively still based on the optical flow 326. For example, a user may be moving the object of interest 305 with multiple similar product codes 120A-N across the optical imaging assembly 130/131 quickly enough that two substantially similar but separate ROIs 335 and 337 are in substantially the same place in two separate images of the series of images 302A/302B. The controller 258 may determine that, based on an optical flow 326, the first product code 120A would not remain in substantially the same place, and thus the first product code 120A and the second product code 120N are separate. Alternatively, the controller 258 may determine that an optical flow 326 of the ROI 335 is below a particular threshold, and thus determine that the first ROI 335 and/or second ROI 336 associated with the first product code 120A and the ROI 337 associated with the second product code 120N are the same. The controller 258 may then determine that the product code 120A is remaining relatively still. In some implementations, the controller 258 may cause the barcode reader 105/106 to indicate to the user that the user should continue moving the product code 120A.

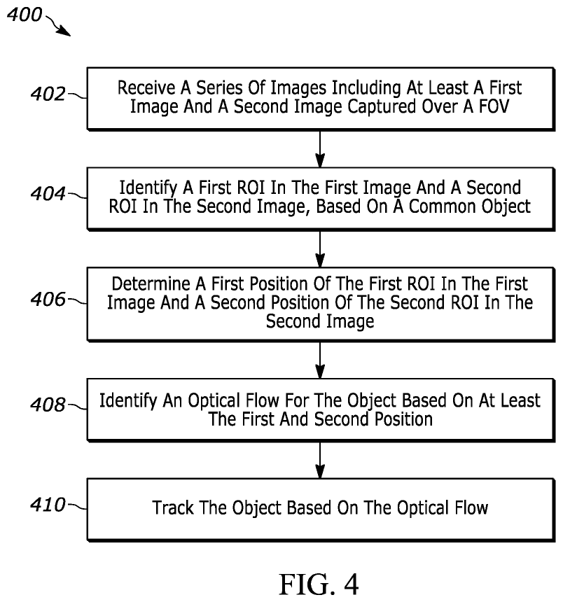

Referring next to FIG. 4, a flowchart 400 illustrates a method for accurate object tracking by a controller 258, which is in communication with an optical imaging assembly 130/131/132. For the sake of clarity, FIG. 4 is discussed with regard to the first image 322, second image 324, optical flow 326, and ROI 335.

Beginning at block 402, the controller 258 receives a series of images 302 from an optical imaging assembly 130/131/132 having a FOV. The series of images 302 includes at least a first image 322 and a second image 324, captured over a FOV. In some implementations, the controller 258 receives the first image 322 and the second image 324 in real time (i.e., the controller 258 receives each image separately). In other implementations, the optical imaging assembly 130/131/132 transmits the series of images 302 in one or more groups simultaneously. At block 404, the controller 258 identifies a first ROI 335 and a second ROI 336 within the first image 322 and the second image 324 respectively, based on a common object 305 between the two images. The event that causes the identification of the first ROI 335 and the second ROI 336 may be, as described above, a decode event, a motion-tracking event, a manual trigger event, or any other similar event. Similarly, the first ROI 335 and the second ROI 336 may be a barcode, QR code, RFID tag, product label, or any similar identifying product code or object.

At block 406, the controller 258 determines a first position of the first ROI 335 within the first image 322 and a second position of the second ROI 336 within the second image 324. In some implementations, the controller 258 determines the first position of the first ROI 335 by identifying a first coordinate value along a first axis of the first image 322 corresponding to the ROI 335 and/or identifying a second coordinate value along a second axis of the first image 322 corresponding to the ROI 335. The controller 258 then determines the second position of the second ROI 336 by identifying a third coordinate value along a first axis of the second image 324 corresponding to the ROI 336 and/or identifying a fourth coordinate value along a second axis of the second image 324 corresponding to the ROI 336. Next, at block 408, the controller 258 identifies an optical flow 326 for the object 305 based on at least the first position and the second position. In some implementations, the controller 258 identifies the optical flow 326 for object 305 by calculating the difference in position between the first position and the second position. In such implementations, the controller 258 may calculate the difference in position between the first position and the second position by calculating the difference between the point defined by the first and second coordinate values and the point defined by the third and fourth coordinate values. The controller 258 may further determine a relative direction the ROI 335 moved based on the first image 322 and the second image 324.

At block 410, the controller 258 may then track the object 305 based on the optical flow 326. In some implementations, tracking the object 305 based on the optical flow 326 includes receiving a third image (e.g., a new second image, where the second image is a new first image) and calculating an updated optical flow based on the second image 324 and the third image. The controller 258 then subsequently updates the optical flow 326 with the updated optical flow. In some implementations, the controller 258 calculates an estimated optical flow 328 for the object 305 based on the second position and the optical flow 326. The controller 258 then crops a predicted region of the third image based on the estimated optical flow. The controller 258 may then determine that the predicted region contains the object 305 and update the optical flow 326 accordingly. In some implementations, the controller 258 may direct an illumination light source based on the tracking of the object 305, or based on an estimated optical flow 238.

In yet further implementations, the controller 258 tracks the object 305 by first determining that a distance between the first position and the second position is greater than a predetermined lower threshold and less than a predetermined upper threshold and, in response, identifies the optical flow. For example, the controller 258 determines that the object 305 isn't remaining still nor jumping further than a user would normally be able to move the object 305 between images.

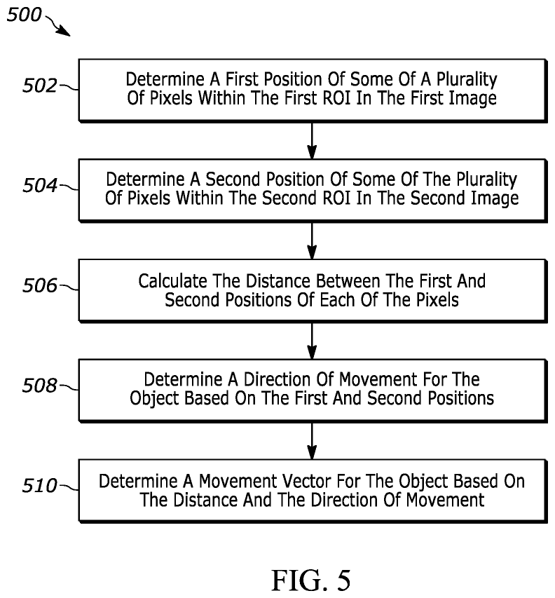

Referring next to FIG. 5, a flowchart 500 illustrates a method for accurate object tracking by a controller 258, which is in communication with an optical imaging assembly 130/131/132. In particular, flowchart 500 details a method for identifying an optical flow. For the sake of clarity, FIG. 5 is discussed with regard to the object 305, first image 322, second image 324, optical flow 326, first ROI 335, and second ROI 336.

Beginning at block 502, the controller 258 determines a first position of each of a set of pixels within the first ROI 335 for the object 305 within the first image 322. Similarly, at block 504, the controller determines a second position of each of the set of pixels within the second ROI 336 of the object 305 within the second image 324. In the exemplary embodiment of FIG. 5, each of the set of pixels within the first ROI 335 within the first image 322 are matched with each of the set of pixels within the second ROI 336 within the second image 324. The controller 258 may determine the first position and the second position of each of the set of pixels similarly to determining the position of the first ROI 335 and the position of the second ROI 336 as described in FIG. 4 above.

At block 506, the controller 258 calculates the distance between the first position and the second position of each of the set of pixels within the ROIs 335 and 336. At block 508, the controller 258 further determines a direction of movement for the object 305 based on the first position and the second positions for each of the set of pixels within the ROls 335 and 336. The controller 258 may calculate the distance and determine the direction of the object 305 movement by using coordinates, as described in FIG. 4 above. At block 510, based on the distance and the direction of the movement, the controller 258 determines a movement vector for the object 305. In some implementations, the controller 258 may determine a separate movement vector for each pixel, which may in turn comprise the optical flow 326. In further implementations, the controller 258 calculates an average movement vector for the set of pixels within the ROIs 335 and 336, which may in turn comprise the optical flow 326. In still further implementations, the controller 258 determines either the maximum movement vector or the minimum movement vector of the movement vectors for the pixels, which may in turn comprise the optical flow 326.

Unlike present techniques, the controller 258 may track the object 305 using the set of pixels even for cylindrical objects, objects without a fixed-volume, objects with a spectral reflection, or objects with a tilted barcode. For example, the controller 258 may determine that a set of pixels comprises an ROI even if the barcode is turned or distorted due to changes in the shape of the object.

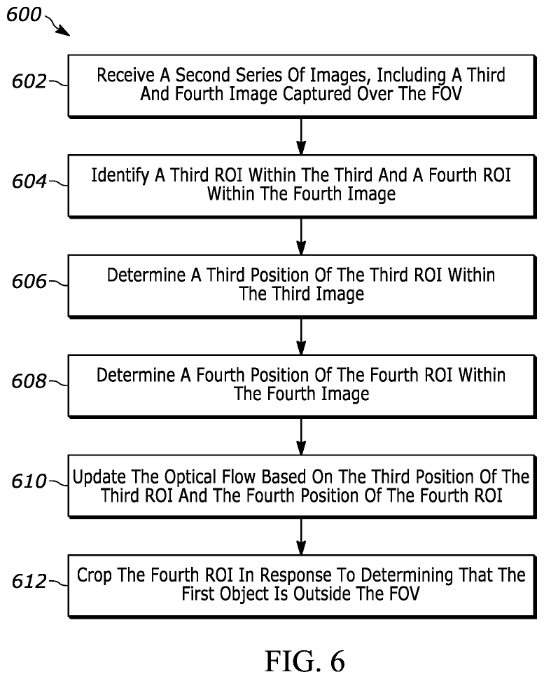

Referring next to FIG. 6, a flowchart 600 illustrates a method for accurate object tracking by a controller 258, which is in communication with an optical imaging assembly 130/131/132. Beginning at block 602, the controller 258 receives a second series of images from the optical imaging assembly 130/131/132, including a third image and a fourth image captured over the FOV. In some implementations, the third image may be the second image 324 and the fourth image may be a third image captured after the first image 322 and the second image 324. In implementations in which multiple objects are visible, the third image may be the first image 322 and the fourth image may be the second image 324. At block 604, the controller 258 identifies a third ROI within the third image and a fourth ROI within the fourth image based on a common object between the images. Similar to identifying the first ROI 335 and the second ROI 336, the controller 258 may make the determination based on an event as detailed in FIGS. 3B and 4 above. In some implementations in which the second object is substantially similar to the first object, the controller may identify the second object by calculating a distance between the first object and the second object, and subsequently determining that the distance between the first object and the second object exceeds a pre-determined threshold. As such, the controller 258 may determine that the second object is distinct from the first object based on the determination that the distance between the first object and the second object exceeds the pre-determined threshold.

At block 606, the controller 258 determines a third position of the third ROI within the third image. At block 608, the controller 258 determines a fourth position of the fourth ROI within the fourth image. In some implementations, the controller 258 determines the third position of the third ROI by identifying a first coordinate value along a first axis of the third image corresponding to the third ROI and/or identifying a second coordinate value along a second axis of the third image corresponding to the third ROI. The controller 258 then determines the fourth position of the fourth ROI by identifying a third coordinate value along a first axis of the fourth image corresponding to the fourth ROI and/or identifying a fourth coordinate value along a second axis of the fourth image corresponding to the fourth ROI. In further implementations, the controller 258 may determine the third and fourth positions of the third and fourth ROI, respectively, by determining a third and fourth position for each of a set of pixels within the third ROI within the third image and the fourth ROI within the fourth image, as described in FIG. 5 above.

After determining the third position of the third ROI and the fourth position of the fourth ROI at blocks 606 and 608, the controller 258 may calculate a distance between the third and fourth positions, and determine a direction for movement of the object. At block 610, the controller 258 then updates the optical flow 326 based at least on the third and fourth positions. In some implementations, the controller 258 updates the optical flow 326 further based on the calculated distance and determined direction. At block 612, the controller 258 crops the fourth ROI in response to determining that the first ROI 335 is outside the FOV.

Though the implementations described in FIGS. 4-6 may be implemented on their own, the implementations and methods may also be part of a broader implementation as described in FIG. 7 below. Depending on the implementation, the methods of FIGS. 4-6 may also be branches or potential embodiments of the method described in FIG. 7 below.

Referring next to FIG. 7, a flowchart 700 illustrates a method for accurate object tracking by a controller 258, which is in communication with an optical imaging assembly 130/131/132. In the exemplary implementation of FIG. 7, to further address situations in which barcodes cannot be easily and/or quickly decoded, the controller 258 identifies and tracks one or more key-points of the barcodes throughout a series of frames and/or images. The controller 258 can then calculate an optical flow for the key-points to determine the location of the barcode even where it cannot be decoded.

Beginning at block 702, the controller 258 receives a series of images including at least a first image and a second image, similar to block 402 of FIG. 4. Next, at block 704, the controller 258 identifies a first point within the first image and a second point within the second image, the first point and the second point both corresponding to one or more key-points (also known as key pixel points) on a barcode 120 visible in both the first image and the second image. Depending on the implementation, a key-point of the barcode 120 may be a corner of the barcode 120, a point along the edge of the barcode 120, or a distinctive marking on the barcode 120. In further implementations, the key-points may be anywhere in the image frame relative to the barcode. Though FIG. 7 specifically refers to a barcode, the controller 258 may, in some implementations, instead identify a point on any other suitable identifying tag, as described in more detail above.

In some implementations, the first point is defined by a first x-coordinate and a first y-coordinate of the first image. In further implementations, the second point is defined by a second x-coordinate and a second y-coordinate of the second image. Similarly, any number of N points throughout N images may be defined by an x-coordinate and a y-coordinate within the corresponding Nth image.

Next, at block 706, the controller 258 identifies an optical flow for the barcode 120 based on at least the first point and the second point. In some implementations, the controller 258 identifies the optical flow for the barcode 120 based on one or more movement vectors for the key-points. The controller 258 may subsequently associate the movement vectors with each respective image. For example, the controller 258 may determine that a key-point has a movement vector of 1 inch from left to right between a first image and a second image. The controller 258 may then register that movement vector with the first or second image. In some implementations, the controller 258 calculates the movement vector by calculating a first distance between the x-coordinates of a first position of a key-point and a second position of the key-point, a second distance between the y-coordinates of a first position of the key-point and a second position of the key-point, and determining a direction of movement for the key-point based on the first and second distances.

In some implementations, the controller 258 assigns each key-point a signature based on the point in question as well as on surrounding information. For example, the signature for a key-point that is the corner of a barcode may include information denoting that the barcode extends relatively down and to the right, but not in other directions. Depending on the implementation, the controller 258 calculates the optical flow using the assigned signatures. For example, the signature for a key-point can be a descriptor that expresses a difference of gradients in the pixel neighborhood or other similarly suitable information regarding the gradients in the pixel neighborhood.

At block 708, the controller 258 tracks the barcode 120 based on the optical flow. Depending on the implementation, the controller 258 then tracks, traces, and/or decodes the barcode 120 in real time using the calculated movement vectors. In some implementations, the controller uses the optical flow to determine and/or predict a location for the barcode 120 in a second image after the first image. In some such implementations, the controller 258 may determine that an object overlapping a determined location is the barcode 120. The controller 258 then refrains from reporting the barcode to the user to avoid decoding the barcode a second time. Alternatively, the controller 258 may refrain from reporting the barcode to the user unless the controller 258 detects the key-points outside of the determined area.

In other implementations, the controller 258 can decode the barcode in the second image or some later image. In such implementations, the controller 258 may determine, based on the location, the key-points, and/or the decode data, that the barcode is barcode 120. The controller 258 then refrains from reporting the barcode to the user, much as noted above. In further implementations, the controller 258 may decode the barcode 120 in the second or later image and internally update the position and/or optical flow of the barcode without notifying a user. The controller 258 may instead determine, based on the location and/or the decode data, that the barcode in the second image is a different barcode 120N and report the presence of a new barcode to the user and/or begin tracking the barcode 120N using a second optical flow simultaneously with the first barcode 120A. In further implementations, the controller 258 may identify a second set of key-points for the barcode 120N before tracking or may further use one of the embodiments outlined in FIGS. 4-6 above.

In implementations in which the controller 258 determines that a second barcode 120N is present in the FOV of the scanning system 100A/B, the controller 258 may determine that the second barcode 120N is present along with first barcode 120A. As is noted above, depending on the implementation, the controller 258 may identify the second barcode 120N as such after determining that an object that is substantially similar to the first barcode 120A is present but is not present in the same position or in a position predicted based on the optical flow. In some implementations, an object is substantially similar when the object has the same layout and/or design as the first barcode 120A. In other implementations, an object is substantially similar when the object is identical to the first barcode 120A (i.e. a duplicate). The controller 258 may also determine that an object is not a barcode and may subsequently determine to not interact with the object, instead continuing the tracking of the first barcode 120A.

After determining that an object is a second barcode 120N, the controller 258 may then identify a first and second position of one or more key-points for the second barcode 120N and identify an optical flow before tracking the second barcode 120N as described for the first barcode 120A above. In some implementations, the controller 258 tracks the second barcode 120N with at least some temporal overlap with the first barcode 120A. Put another way, the controller 258 may track the second barcode 120N and the first barcode 120A simultaneously, separately, or with some level of overlap.

Further, the controller 258 may track any number of barcodes simultaneously and/or in real-time as described above. As such, the controller 258 may track any number of barcodes until the tracked barcodes are no longer present in the FOV or until the controller 258 determines that a decoding session is over.

In some implementations, the controller 258 receives optical flow data from the hardware of the scanning system 100A/B. In such implementations, the controller 258 only identifies key-points in the first image and tracks the barcode using the received optical flow data and the movement of the key-points as described above. As such, the controller 258 may implement the techniques as described above using optical flow data received from hardware rather than calculating the optical flow.

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A method for barcode tracking and scanning using an imaging system including an optical assembly having a field of view (FOV), the method comprising:
receiving, from the optical imaging assembly, a series of images including at least a first image and a second image captured over the FOV;
decoding a barcode in the first image;
identifying a first position of a key-point within the first image;
identifying a second position of the key-point within the second image;
calculating an optical flow for the barcode based on at least the first position and the second position; and
tracking the barcode based on the optical flow.

2. The method of claim 1, wherein:
the first position is defined by a first x coordinate and a first y coordinate within the first image;
the second position is defined by a second x coordinate and a second y coordinate within the second image; and
calculating the optical flow includes:
calculating a first distance between the first x coordinate and the second x coordinate;
calculating a second distance between the first y coordinate and the second y coordinate;
determining a direction of movement based on the first distance and the second distance; and
determining a movement vector for the optical flow based at least on the first distance, the second distance, and the direction of movement.

3. The method of claim 1, wherein the tracking includes:
predicting, using at least the optical flow and the key-point, a location of the barcode in an additional image of the series of images, wherein the additional image is taken after the first image.

4. The method of claim 3, further comprising:
decoding the barcode in the additional image;
determining an additional position of the decoded barcode;
comparing the predicted location of the barcode and the additional position of the decoded barcode in the additional image;
determining that the additional position of the barcode and the predicted location of the barcode overlap; and
updating the optical flow using the additional position.

5. The method of claim 3, further comprising:
decoding a barcode in the additional image;
determining an additional position of the decoded barcode;
comparing the predicted location of the barcode and the additional position of the decoded barcode in the additional image;
determining that the additional position of the barcode and the predicted location of the decoded barcode do not overlap; and
in response to determining that the additional position of the barcode and the predicted location of the decoded barcode do not overlap, determining that the decoded barcode is different from the first barcode.

6. The method of claim 1, wherein the key-point is a first key-point, the barcode is a first barcode, the optical flow is a first optical flow, and further comprising:
determining that a second barcode is present in a third image of the series of images;
decoding a second barcode;
identifying a first position of a second key-point within the image;
identifying a second position of the second key-point within a fourth image;
calculating a second optical flow for the second barcode based on at least the first position of the second key-point and the second position of the second key-point; and
tracking the second barcode based on the optical flow.

7. The method of claim 6, wherein tracking the second barcode and tracking the first barcode are performed simultaneously.

8. The method of claim 1, further comprising:
decoding a portion of an additional image of the series of images, wherein the additional image is taken after the first image and wherein the portion does not include the predicted location.

9. The method of claim 1, wherein the calculating and the tracking are performed in real time.

10. The method of claim 1, wherein identifying the first position of the key-point includes:
generating a signature for the key-point, the signature including information on gradients surrounding the key-point.

11. The method of claim 10, wherein identifying the second position of the key-point includes:
determining that a key-point in the second image has a signature that matches the signature for the key-point.

12. A method for barcode tracking and scanning using an imaging system including an optical assembly having a field of view (FOV), the method comprising:
receiving, from the optical imaging assembly, a series of images including at least a first image and a second image captured over the FOV;
decoding a barcode in the first image;
identifying a position of a key-point within the first image;
receiving optical flow data for the key-point; and
tracking the barcode based on the optical flow data.

13. The method of claim 12, wherein the tracking includes:
predicting, using at least the optical flow data and the key-point, a location of the barcode in an additional image of the series of images, wherein the additional image is taken after the first image.

14. The method of claim 13, further comprising:
decoding the barcode in the additional image;
determining an additional position of the decoded barcode;
comparing the predicted location of the barcode and the additional position of the decoded barcode in the additional image;
determining that the additional position of the barcode and the predicted location of the barcode overlap; and
updating the optical flow data using the additional position.

15. The method of claim 13, further comprising:
decoding a barcode in the additional image;
determining an additional position of the decoded barcode;
comparing the predicted location of the barcode and the additional position of the decoded barcode in the additional image;
determining that the additional position of the barcode and the predicted location of the decoded barcode do not overlap; and
in response to determining that the additional position of the barcode and the predicted location of the decoded barcode do not overlap, determining that the decoded barcode is different from the first barcode.

16. The method of claim 12, wherein the position of the key-point is a first position of a first key-point, the barcode is a first barcode, the optical flow information is first optical flow data, and further comprising:
determining that a second barcode is present in a third image of the series of images;
decoding a second barcode;
identifying a second position of a second key-point within the image;
receiving second optical flow data for the second key-point; and
tracking the second barcode based on the second optical flow data.

17. The method of claim 16, wherein tracking the second barcode and tracking the first barcode are performed simultaneously.

18. The method of claim 12, further comprising:
decoding a portion of an additional image of the series of images, wherein the additional image is taken after the first image and wherein the portion does not include the predicted location.

19. The method of claim 12, wherein the receiving and the tracking are performed in real time.

20. The method of claim 12, wherein identifying the position of the key-point includes:
generating a signature for the key-point, the signature including information on gradients surrounding the key-point.

21. A method for object tracking using an imaging system including an optical assembly having a field of view (FOV), the method comprising:
receiving, from the optical imaging assembly, a series of images including at least a first image and a second image captured over the FOV;
identifying a first region of interest (ROI) within the first image and a second ROI within the second image, wherein the first ROI and the second ROI are based on an object common to the first image and the second image;
determining a first position of the first ROI within the first image and a second position of the second ROI within the second image;
identifying an optical flow for the object based on at least the first position and the second position, wherein the optical flow is representative of a change in position between the first position and the second position; and
tracking the object based on the optical flow.

22. The method of claim 21, wherein the identifying an optical flow further includes:
calculating a distance between the first position and the second position;
determining a direction of movement for the object based on the first position and the second position; and
determining a movement vector for the object based on the distance and the direction of movement.

23. The method of claim 22, wherein the determining the first position of the first ROI includes determining a first position of at least some of a plurality of pixels within the first ROI within the first image;
wherein determining the second position of the second ROI includes determining a second position of at least some of the plurality of pixels within the second ROI within the second image; and
wherein determining the distance between the first position and the second position includes determining a distance between (i) the first position of the some of the plurality of pixels and (ii) the second position of the some of the plurality of pixels.

24. The method of claim 22, further comprising:
determining that the movement vector is below a pre-determined threshold for a predetermined period of time; and
indicating that the object has been scanned previously.

25. The method of claim 21, further comprising:
calculating, using a predictive algorithm, a third position of a third ROI based on the first position and the second position; and
updating the optical flow based on the third position.

26. The method of claim 21, wherein the tracking the object comprises:
receiving, from the optical imaging assembly, a third image of the series of images captured over the FOV;
calculating an estimated optical flow based at least on the second position and the optical flow;
cropping a predicted ROI of the third image based on the estimated optical flow;
determining that the predicted ROI contains the object; and
updating the optical flow with the estimated optical flow.

27. The method of claim 21, wherein the tracking the object comprises:
determining that a distance between the first position and the second position is greater than a predetermined lower threshold and less than a predetermined upper threshold; and
wherein the identifying the optical flow is in response to determining that the distance is greater than the predetermined lower threshold and less than the predetermined upper threshold.

28. The method of claim 21, wherein the series of images is a first series of images and the object is a first object, further comprising:
receiving, from the optical imaging assembly, a second series of images including at least a third image and a fourth image captured over the FOV;
identifying a third ROI within the third image and a fourth ROI within the fourth image, based on a second object common to the third image and the fourth image;
determining a third position of the third ROI within the third image and a fourth position of the fourth ROI within the fourth image;
updating the optical flow based on the third position of the third ROI and the fourth position of the fourth ROI; and
cropping the fourth ROI in response to determining that the first object is outside the FOV.

29. The method of claim 28, wherein the identifying the third ROI includes:
determining that the third ROI is substantially similar to the first ROI;
calculating a distance between the third ROI and the first ROI in the FOV;
determining that the distance between the third ROI and the first ROI exceeds a pre-determined threshold; and
determining that the third ROI is distinct from the first ROI based on the determination that the distance between the third ROI and the first ROI exceeds the pre-determined threshold.

30. The method of claim 21, further comprising directing an illumination source based on the tracking of the object.

31. An imaging system for object tracking over a field of view (FOV), comprising:
an optical imaging assembly having the FOV and configured to capture a series of images including at least a first image and a second image over the FOV; and
a controller configured to:
receive, from the optical imaging assembly, the series of images including at least the first image and the second image;
identify a first region of interest (ROI) within the first image and a second ROI within the second image, wherein the first ROI and the second ROI are based on an object common to the first image and the second image;
determine a first position of the first ROI within the first image and a second position of the second ROI within the second image;
identify an optical flow for the object based on at least the first position and the second position, wherein the optical flow is representative of a change in position between the first position and the second position; and
track the object based on the optical flow.

32. The system of claim 31, wherein the identifying the optical flow includes:
calculating a distance between the first position and the second position;
determining a direction of movement for the object based on the first position and the second position; and
determining a movement vector for the object based on the distance and the direction of movement.

33. The system of claim 32, wherein the determining the first position of the first ROI includes determining a first position of at least some of a plurality of pixels within the first ROI within the first image;
wherein the determining the second position of the second ROI includes determining a second position of at least some of the plurality of pixels within the second ROI within the second image; and
wherein the determining the distance between the first position and the second position includes determining a distance between (i) the first position of the some of the plurality of pixels and (ii) the second position of the some of the plurality of pixels.

34. The system of claim 32, wherein the controller is further configured to:
determine that the movement vector is below a pre-determined threshold for a predetermined period of time; and
indicate that the object has been scanned previously.

35. The system of claim 31, wherein the controller is further configured to:
calculate, using a predictive algorithm, a third position of a third ROI based on the first position and the second position; and
update the optical flow based on the third position.

36. The system of claim 31, wherein the tracking the object comprises:
receiving, from the optical imaging assembly, a third image of the series of images captured over the FOV;
calculating an estimated optical flow based at least on the second position and the optical flow;
cropping a predicted ROI of the third image based on the estimated optical flow;
determining that the predicted ROI contains the object; and
updating the optical flow with the estimated optical flow.

37. The system of claim 31, wherein the tracking the object comprises:
determining that a distance between the first position and the second position is greater than a predetermined lower threshold and less than a predetermined upper threshold; and
wherein the identifying the optical flow is in response to determining that the distance is greater than the predetermined lower threshold and less than the predetermined upper threshold.

38. The system of claim 31, wherein the series of images is a first series of images and the object is a first object, the controller further configured to:
receive, from the optical imaging assembly, a second series of images including at least a third image and a fourth image captured over the FOV;
identify a third ROI within the third image and a fourth ROI within the fourth image, based on a second object common to the third image and the fourth image;
determine a third position of the third ROI within the third image and a fourth position of the fourth ROI within the fourth image;
update the optical flow based on the third position of the third ROI and the fourth position of the fourth ROI; and
crop the fourth ROI in response to determining that the first object is outside the FOV.

39. The system of claim 38, wherein the identifying the third ROI includes:
determining that the third ROI is substantially similar to the first ROI;
calculating a distance between the third ROI and the first ROI in the FOV;
determining that the distance between the third ROI and the first ROI exceeds a pre-determined threshold; and
determining that the third ROI is distinct from the first ROI based on the determination that the distance between the third ROI and the first ROI exceeds the pre-determined threshold.

40. The system of claim 31, further comprising an illumination source, and wherein the controller is further configured to direct the illumination source based on the tracking of the object.
